(19) United States
(12) Patent Application Publication
(10) Pub. No.: US 2013/0057820 A1
(43) Pub. Date: Mar. 7, 2013

(54) LIQUID CRYSTAL DISPLAY DEVICE

(71) Applicants: Yosuke HYODO, Chiba (JP); Yasushi Tomioka, Hitachinaka (JP); Masahiko Suzuki, Mobara (JP); Toshiki Kaneko, Chiba (JP); Noboru Kunimatsu, Chiba (JP)

(72) Inventors: Yosuke HYODO, Chiba (JP); Yasushi Tomioka, Hitachinaka (JP); Masahiko Suzuki, Mobara (JP); Toshiki Kaneko, Chiba (JP); Noboru Kunimatsu, Chiba (JP)

(73) Assignee: Japan Display East Inc.

(21) Appl. No.: 13/596,092

(22) Filed: Aug. 28, 2012

(30) Foreign Application Priority Data
Sep. 6, 2011 (JP) 2011-193603

(51) Int. Cl. G02F 1/1339

(52) U.S. Cl. 349/155

(57) ABSTRACT

In a liquid crystal display device using a cylindrical spacer to define the gap between a TFT substrate and a counter substrate, the TFT substrate does not include an organic passivation film, in which the cylindrical spacer is formed on an inorganic passivation film. An overcoat film is formed to cover a black matrix and color filters in the counter substrate. A concavo-convex mount is formed in the overcoat film. The top of the cylindrical spacer is brought into contact with the concavo-convex mount. The oriented film is not attached to the top of the cylindrical spacer and the convex portion of the concavo-convex mount. Thus, even if horizontal displacement occurs in the TFT substrate or the counter substrate, it is possible to prevent the occurrence of bright spots due to the scraping of the oriented film caused by the friction between the TFT substrate and the counter substrate.

### CLAIM OF PRIORITY

The present application claims priority from Japanese Patent Application JP 2011-193603 filed on Sep. 6, 2011, the content of which is hereby incorporated by reference into this application.

### FIELD OF THE INVENTION

The present invention relates to a liquid crystal display device, and more particularly, to a liquid crystal display device for preventing bright spots due to oriented film scrapings.

### BACKGROUND OF THE INVENTION

In a liquid crystal display device, there is provided a TFT substrate in which pixel electrodes, thin film transistors (TFT) and the like are arranged in a matrix form. Further, a color filter substrate is disposed opposite to the TFT substrate, in which color filters and the like are formed at locations corresponding to the pixel electrodes of the TFT substrate. Then, a liquid crystal is sandwiched between the TFT substrate and the counter substrate. Thus, the liquid crystal display device forms an image by controlling the transmittance of light of the liquid crystal molecules for each pixel.

In the liquid crystal display device, an oriented film is formed on the boundary faces of the liquid crystal layer in the counter substrate and in the TFT substrate. A rubbing process or a photo-alignment process is applied to the oriented film to determine the initial orientation of the liquid crystal molecules. Then, the liquid crystal molecules from the initial orientation are twisted or rotated by the electric field to control the amount of light passing through the liquid crystal layer.

At the same time, it is necessary to form a spacer between the counter substrate and the TFT substrate in order to control the thickness of the liquid crystal layer. In the existing technology, beads or other particles are dispersed in the liquid crystal layer to serve as the spacer. However, in recent years, there has been developed a technology for controlling the gap between the TFT substrate and the counter substrate by a cylindrical spacer formed in the counter substrate, in order to achieve more precise control of the gap (liquid crystal layer) between the TFT substrate and the counter substrate.

The use of the cylindrical spacer leads to a new problem. For example, Japanese Unexamined Patent Publication No. 2007-164134 describes a configuration that reduces the friction force due to displacement of the cylindrical spacer when the counter substrate is pushed from the outside, and that allows the cylindrical spacer to easily return to the original position when the external pressure disappears. To achieve this configuration, Japanese Unexamined Patent Publication No. 2007-164134 discloses a mount which is formed in the TFT substrate and has a smaller area than the area of the top of the cylindrical spacer. Further, when the cylindrical spacer is displaced in the horizontal direction, there is also a problem of the scraping of the oriented film. Other references for the scraping of the oriented film, or for the cylindrical spacer, are Japanese Unexamined Patent Publication Nos. 2007-328247, 2008-170690, 2009-58618, 2009-282262, and 2010-8616.

Japanese Unexamined Patent Publication No. 2011-22232 describes a configuration in which a sub cylindrical spacer is formed. A mount corresponding to the sub cylindrical spacer has a concave-convex pattern. In general, the sub cylindrical spacer is not brought into contact with the mount. The sub cylindrical spacer is brought into contact with the mount in which the concave-convex pattern is formed, only when a load is applied to the substrate. Japanese Unexamined Patent Publication No. 2011-22232 aims to reduce the load applied to the sub cylindrical spacer by forming the concave-convex pattern, thereby preventing the sub cylindrical spacer from being destroyed.

Note that Japanese Unexamined Patent Publication No. 2007-164134 corresponds to U.S. Pat. No. 7684003, Japanese Unexamined Patent Publication No. 2009-58618 corresponds to US Patent Application No. 2009/0059155, Japanese Unexamined Patent Publication No. 2009-282262 corresponds to US Patent Application No. 2011/0080548, and Japanese Unexamined Patent Publication No. 2011-22232 corresponds to US Patent Application No. 2011/0013131.

### SUMMARY OF THE INVENTION

In general, a cylindrical spacer is formed on the counter substrate. Further, a mount is formed on the TFT substrate at the position facing the cylindrical spacer. Here, the mount includes not only a protrusion formed on the side of the TFT substrate, but also one with a flat surface facing the cylindrical spacer or one with a concave portion. In other words, in this specification, the mount is the structure on the side of the TFT substrate facing the cylindrical spacer.

In the liquid crystal display device, an oriented film is formed on the surfaces contacting the liquid crystal layer in the counter substrate and in the TFT substrate. In the counter substrate, the cylindrical spacer is relatively high, so that the oriented film is not very likely to be formed on the top of the cylindrical spacer. On the other hand, in the TFT substrate, the mount is lower than the cylindrical spacer, so that the oriented film is also formed on the surface of the mount. When the cylindrical spacer is brought into contact with the surface of the mount on which the oriented film is formed, the oriented film on the surface of the mount is scraped.

In other words, when the TFT substrate and the counter substrate are expanded and contracted at different rates due to temperature cycle testing or other tests for the liquid crystal display device, or when an external pressure is applied to the counter substrate, the cylindrical spacer is displaced in the horizontal direction. At this time, the oriented film on the mount is scraped by the cylindrical spacer. When the oriented film scrapings are mixed in the liquid crystal layer, bright spots occur and the image quality is degraded.

It would be desirable to prevent the scraping of the oriented film caused by the cylindrical spacer, and to prevent the occurrence of bright spots.

The present invention overcomes the above problem, and a typical aspect of the present invention is as follows. There is provided a liquid crystal display device including a TFT substrate, a counter substrate, and a liquid crystal sandwiched between the TFT substrate and the counter substrate. The TFT substrate includes a display area in which pixels each having a pixel electrode and a TFT are arranged in a matrix form, and a peripheral area of the display area. In the counter substrate, an overcoat film is formed on a black matrix and color filters. The counter substrate includes a display area corresponding to the display area of the TFT substrate, and a peripheral area having a flat portion corresponding to the peripheral area of the TFT substrate. The gap between the TFT substrate and the counter substrate is defined by a cylindrical spacer formed on the TFT substrate. A concavo-convex mount facing the cylindrical spacer is formed in the display area on the overcoat film of the counter substrate. A concave portion and a convex portion are formed on the bottom surface of the concavo-convex mount, in which the top of the convex portion is lower than the flat portion. The thickness of an oriented film in the convex portion is smaller than the thickness of an oriented film in the concave portion. The top of the cylindrical spacer is brought into contact with two or more concave portions formed on a bottom surface of the concavo-convex mount. The diameter of the bottom surface of the concavo-convex mount is greater than the diameter of the top of the cylindrical spacer.

According to another aspect of the present invention, in the liquid crystal display device described in paragraph (1), the cylindrical spacer formed in the peripheral area of the TFT substrate is brought into contact with a flat mount on the overcoat film in the peripheral area of the counter substrate.

According to still another aspect of the present invention, in the liquid crystal display device described in paragraph (1) or (2), an organic passivation film is not present in the TFT substrate.

According to the present invention, in a liquid crystal display device including a cylindrical spacer and using an oriented film, it is possible to prevent the scraping of the oriented film caused by the cylindrical spacer. Thus, the production yield of liquid crystal display devices can be increased. Further, it is also possible to prevent the scraping of the oriented film due to the horizontal displacement of the cylindrical spacer caused by the temperature cycle after shipping or by the external pressure on the counter substrate. As a result, it is possible to prevent defects in the market.

In the liquid crystal display device in which liquid crystal is injected by a dropping method, the number of cylindrical spacers is small, so that the stress between one cylindrical spacer and the mount is large. However, according to the present invention, the oriented film is not present in the mount contacting the cylindrical spacer, or even if the oriented film is formed, the film thickness is smaller than the other parts. Thus, it is possible to prevent the oriented film from being scraped, thereby preventing the occurrence of bright spots.

### BRIEF DESCRIPTION OF THE DRAWINGS

FIG. 1 is a cross-sectional view of a liquid crystal display device according to the present invention;

FIG. 2 is a detailed cross-sectional view of the state in which a cylindrical spacer is brought into contact with a concavo-convex mount;

FIG. 3 is a schematic cross-sectional view of the liquid crystal display device according to the present invention;

FIG. 4 is a schematic view illustrating the problem of the liquid crystal display device of the related art;

FIG. 5 is a perspective view of an example of convex portions formed on the bottom surface of the concavo-convex mount;

FIG. 6 is a schematic cross-sectional view illustrating the definition of the tilt angle of the convex portion formed on the bottom surface of the concavo-convex mount;

FIG. 7 is a plan view showing a position of the cylindrical spacer;

FIG. 8 is a plan view showing another position of the cylindrical spacer;

FIG. 9 is a manufacturing process of a TFT substrate, which is related to the present invention;

FIG. 10 is a manufacturing process of a counter substrate, which is related to the present invention;

FIG. 11 is a perspective view of the relationship between the concavo-convex mount and the cylindrical spacer, according to a second embodiment;

FIG. 12 is a cross-sectional view of the liquid crystal display device in which concave mounts are formed; and

FIG. 13 is a cross-sectional view of the liquid crystal display device in which concave-convex mounts are formed.

### DETAILED DESCRIPTION OF THE PREFERRED EMBODIMENTS

Before the present invention is described, a comparative example will be described with reference to the drawing. FIG. 12 is a schematic cross-sectional view of a liquid crystal display device as a comparative example. In FIG. 12, DI represents a display area and PE represents a peripheral area other than the display area. In FIG. 12, cylindrical spacers 150 are formed on the outside of a sealing material 140 in PE. However, there is also the case in which the cylindrical spacer 150 is only present in the inside of the sealing material 140 and is not present in the outside of the sealing material 140, depending on the product type. The present invention can also be applied to such a configuration.

In FIG. 12, an organic passivation film 107 is formed on a TFT substrate 100. The organic passivation film 107 also serves as a flattering film and is thick with a thickness of about 1.5 to 2 μm. In FIG. 12, actually the components such as lines, electrodes, semiconductor film, gate insulating film, inorganic passivation film are formed between the TFT substrate 100 of glass and the organic passivation film 107. However, FIG. 12 is a schematic view and these layers are omitted.

A hole or a concave portion is formed on the organic passivation film 107 by means of exposure or half exposure. The organic passivation film 107 is removed from the area where the sealing material 140 is formed to bond the TFT substrate 100 and the counter substrate 200 to each other. Further, a concave mount 120 is formed in the TFT substrate 100 at the position facing the cylindrical spacer 150 that is formed in the counter substrate 200. On the TFT substrate 100, the concave mount 120 has a recess in the area where the cylindrical spacer 150 is brought into contact with the concave mount 120. The concave portion is lower than the other parts.

The reason why the concave mount 120 is formed is to maintain the convex state inside the TFT substrate 100 or the counter substrate 200 in the normal operation, as shown in FIG. 3 which will be described later. Now returning to FIG. 12, in general, components such as counter electrode, interlayer insulating film, and pixel electrode are formed on the organic passivation film 101 of the TFT substrate 100. However, FIG. 12 is a schematic view and these layers are omitted. Thus, in FIG. 12, an oriented film 106 is formed on the organic passivation film 107. The oriented film 106 is liquid when it is applied, and is accumulated thick in the lower portion by the leveling effect. In other words, the oriented film 106 is made relatively thick also in the concave mounts 120 shown in FIG. 12.

In FIG. 12, an overcoat film 203 is formed on the side of the counter substrate 200. Then, the cylindrical spacer 150 is formed on the overcoat film 203. In general, color filters and black matrix are formed between the overcoat film 203 and the counter substrate 200. However, FIG. 2 is a schematic view and these films are omitted. The oriented film 106 is formed on the overcoat film 203. In FIG. 12, the oriented film 106 is not formed on the top of the cylindrical spacer 150. This is because the cylindrical spacer 150 is relatively high, so that the oriented film 106, which is liquid at the time of application, is not likely to be accumulated in the top of the cylindrical spacer 150. Also on the side of the counter substrate 200, the oriented film 106 is not formed in the sealing material 140, similarly to the case of the TFT substrate 100.

In FIG. 12, the cylindrical spacer 150 of the counter substrate 200 is disposed facing the concave mount 120 of the TFT substrate 100, in which the oriented film 106 is present in the concave mount 120. For this reason, when horizontal displacement or other failure occurs in the cylindrical spacer 150, the oriented film 106 is scarped and scrapings of the oriented film occur. This causes bright spots.

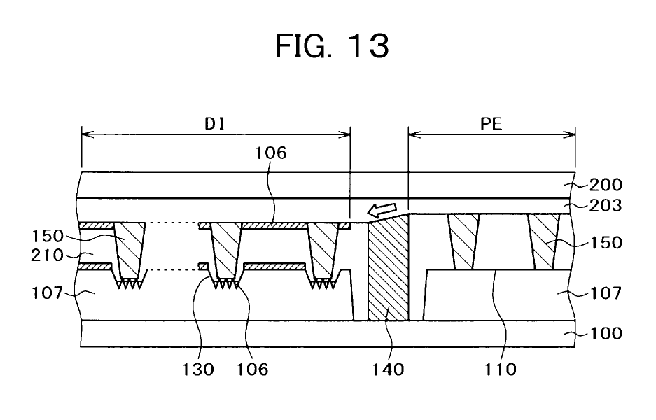

FIG. 13 shows the solution of this problem, in which the concave-convex pattern is formed on the bottom of the concave mount. Hereinafter such a mount will be referred to as a concavo-convex mount 130. In the concavo-convex mount 130 shown in FIG. 13, the liquid oriented film is accumulated in the concave portion but is not present in the convex portion with which the cylindrical spacer is brought into contact. Thus, there is no risk that the oriented film will be scraped and scrapings of the oriented film will occur in the concavo-convex mount 130 after of the oriented film. Note that the configuration of FIG. 13 is the same as the configuration of FIG. 12 except the concavo-convex mount 130, and thus the detailed description thereof will be omitted. The configuration shown in FIG. 13 has been made by the same inventors as those of the present invention, and is currently patent pending.

As described above, according to the configuration of FIG. 13, it is possible to prevent the oriented film from being scraped. However, the configuration of FIG. 13 requires the concavo-convex mount 130 to be formed in the organic passivation film 107. The organic passivation film 107 may be or may not be present depending on the type of the liquid crystal display device. In other words, the configuration of FIG. 13 may not be used for liquid crystal display devices without including the organic passivation film 107.

In the following embodiments of the present invention, it is possible to prevent the scraping of the orientation film caused by the cylindrical spacer 150 also in the liquid crystal display device without including the organic passivation film 107, by forming the cylindrical spacer 150 on the side of the TFT substrate 100 and by forming the concavo-convex mount 130 in the overcoat film 203 on the side of the counter substrate 200.

### First Embodiment

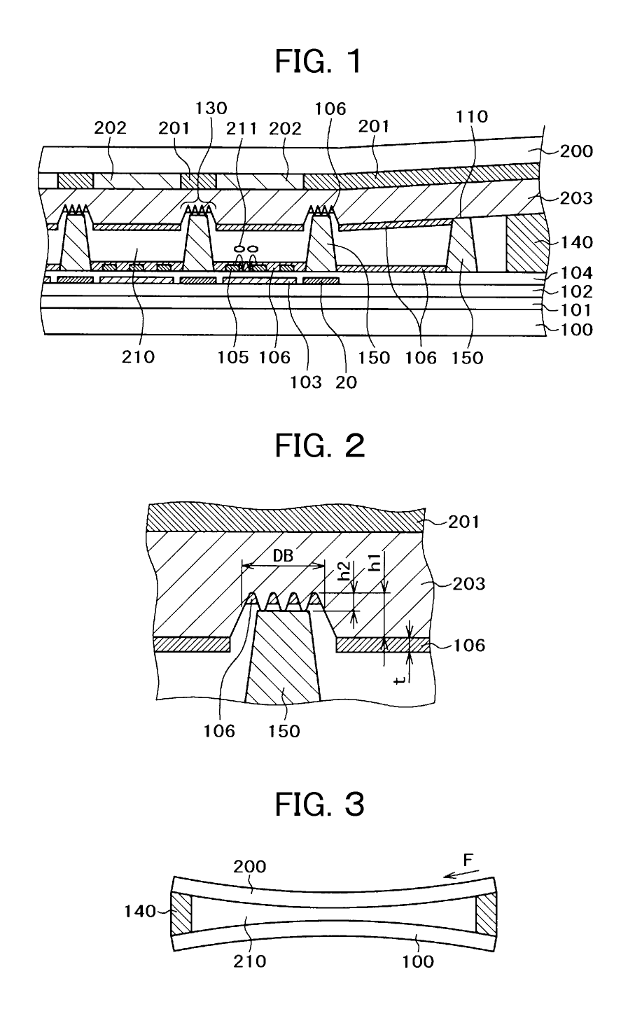

FIG. 1 is a cross-sectional view, showing the present invention in an end portion of a liquid crystal display device. FIG. 1 is a cross-sectional view of an IPS mode liquid crystal display device in which the organic passivation film 107 is not used. In FIG. 1, the area in which color filters 202 are formed in the counter substrate 200 is the display area. Then, the area close to the sealing material 140 is the peripheral area. In FIG. 1, a gate insulating film 101 is formed on the TFT substrate 100. Then, a passivation film 102 is formed on the gate insulating film 101. The passivation film 102 protects TFT not shown.

A pixel electrode 103 is formed flat for each pixel on the passivation film 102. Further, image signal lines 20 are also formed on the passivation film 102. An interlayer insulting film 104 is formed to cover the pixel electrode 103 and the image signal lines 20. A comb-like counter electrode 105 is formed on the pixel electrode 103 with the interlayer insulating film 104 between them. When a voltage is applied between the pixel electrode 103 and the counter electrode 105, an electric field line is generated as shown in the arrow. Thus, a liquid crystal molecule 211 is rotated to control the transmittance of light.

The cylindrical spacer 150 is formed on the image signal line 20 with the interlayer insulating film 104 between them. The configuration in which the cylindrical spacer 150 is formed on the side of the TFT substrate 100 is the feature of the present invention. The oriented film 106 is formed to cover the passivation film 102 and the comb-like counter electrode 105. The liquid oriented film is also applied onto the cylindrical spacer 150. However, the height of the cylindrical spacer 150 is high, so that the oriented film 106 is not formed on the cylindrical spacer 150 by the leveling effect.

The color filters 202 and the black matrix 201 are formed on the side of the counter substrate 200. The area in which the color filters 202 are formed is the display area. The color filter 202 is formed at the position corresponding to the pixel electrode 103. Then, the black matrix 201 is formed to correspond to the area in which the cylindrical spacer 150 and the image signal line 20 are formed. In FIG. 1, the black matrix 201 and the color filter 202 are formed in parallel. However, there may be a case in which the color filter 202 is formed on the black matrix 201. The present invention can also be applied to liquid crystal displays device of this configuration.

The overcoat film 203 is formed to cover the color filter 202 and the black matrix 201. Then, the oriented film 106 is formed on the overcoat film 203. A liquid crystal layer 210 is sandwiched between the TFT substrate 100 and the counter substrate 200, and is sealed by the sealing material 140 formed in the periphery thereof. The oriented film 106 is not applied to the area where the sealing material 140 is formed. If the oriented film 106 is present in the sealing portion 140, the adhesion between the sealing material 140 and each of the substrates decreases. For this reason, the oriented film 106 is prevented by a stopper and the like from being attached to the sealing material 140.

In FIG. 1, the cylindrical spacer 150 is brought into contact with the concavo-convex mount 130 formed in the overcoat film 203 in the display area while, in the peripheral area, the cylindrical spacer 150 is brought into contact with the flat overcoat film 203 in which the concavo-convex mount 130 is not formed. In other words, the peripheral area is formed as a flat mount 110. Thus, the gap between the TFT substrate 100 and the counter substrate 200 is large in the peripheral area. FIG. 3 is a cross-sectional view of this state in an exaggerated manner.

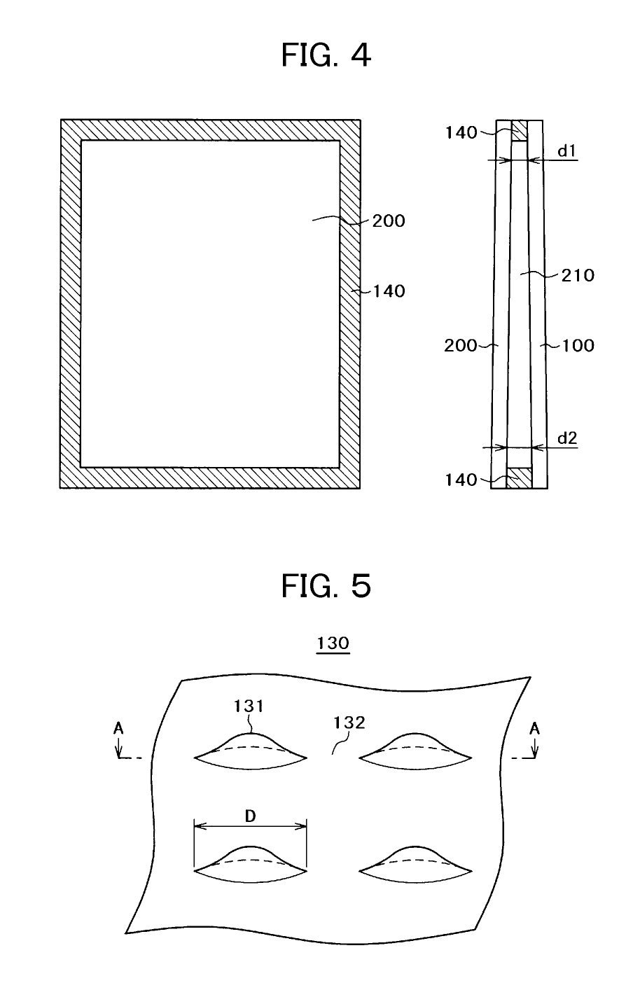

Also in the configuration shown in FIG. 3, when the TFT substrate 100 or the counter substrate 200 is thermally expanded due to a temperature raise, the thermal expansion stress is in the direction indicated by F in FIG. 3, which is not the direction to generate a gap between the TFT substrate 100 and the counter substrate 200. In other words, when the TFT substrate 100 or the counter substrate 200 is thermally expanded, it is possible to prevent the phenomenon shown in FIG. 4 that a distance d1 on the upper side of the liquid crystal display device is greater than a distance d2 on the lower side of the liquid crystal display device.

FIG. 2 is a cross-sectional view of the part of the concavo-convex mount 130 in FIG. 1. In FIG. 2, a distance hi from the surface of the overcoat film 203 to the bottom of the concave portion of the concavo-convex mount 130 is, for example, 0.6 to 0.7 μm. The height of the concave-convex pattern in the bottom surface of the concavo-convex mount 130 is, for example, about 0.35 μm. The thickness of the overcoat film 203 is, for example, 1.5 μm. The film thickness of the flat portion in the overcoat film 203 of the oriented film 106 is, for example, 80 nm. In the concavo-convex mount 130, the oriented film 106 is accumulated in the concave portion, so that the thickness of the oriented film 106 in the concave portion is greater than 80 nm but is smaller than the height of the concave-convex pattern of 0.35 μm. Thus, the oriented film 106 is not present in the bottom surface of the concavo-convex mount 130 after calcination of the oriented film.

In FIGS. 1 and 2, the top of the cylindrical spacer 150 is brought into contact with three convex portions 131 in the concavo-convex mount 130. It is possible to achieve stable contact when the cylindrical spacer is brought into contact with two or more convex portions. However, preferably the top of the cylindrical spacer 150 is brought into contact with three or more convex portions 131. Further, in the concavo-convex mount 130, a diameter DB of the bottom in which the concave-convex pattern is formed should be larger than the diameter of the top of the cylindrical spacer. Note that in FIG. 2, the oriented film 106 is not present on the top of the convex portion 131, or on the top of the cylindrical spacer 150. However, it is also possible to reduce the influence of the scraping of the oriented film, even if the oriented film is not completely absent and is thinly formed on the top of the convex portion 131, or on the top of the cylindrical spacer 150.

Thus, as shown in FIG. 2, the oriented film 106 is not present or very thin if it is present in the contact portion of the cylindrical spacer 150 and the concavo-convex mount 130. With this configuration, the oriented film may not be scraped when the cylindrical spacer 150 is displaced in the horizontal direction.

FIG. 5 is a schematic view of the shape of the bottom of the concavo-convex mount 130, which is a perspective view in which the bottom surface of the protrusion of the convex portion 131 has a circular shape. The concave portion 132 is formed between the convex portions 131. Although, in general, more number of convex portions 131 may be formed in the bottom of the concavo-convex mount 130, FIG. 5 shows a part of the bottom surface. In FIG. 5, a diameter D of the convex portion 131 is, for example, 6 μm. Here, the diameter D represents the diameter in the lower end of the convex portion 131.

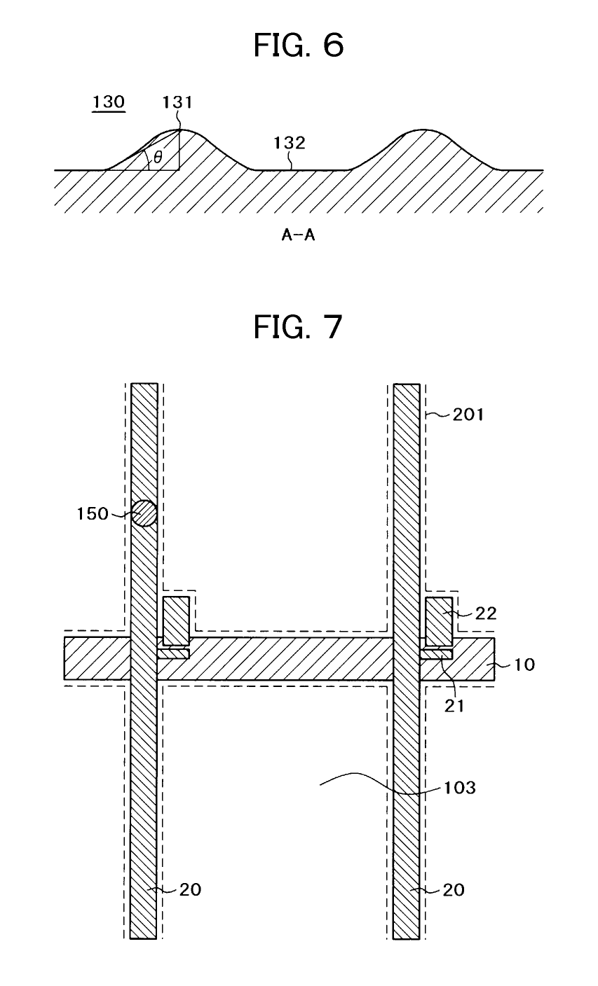

FIG. 6 is a cross-sectional view taken along line A-A of FIG. 5, which shows the definition of the tilt angle θ of the convex portion 131 formed on the bottom surface of the concavo-convex mount 130. In FIG. 6, the tilt angle θ is the angle between the line connecting the top of the convex portion 131 and the beginning of the flat concave portion 132, and the flat concave portion 132. Note that when it is uncertain whether the concave portion 132 is flat or not, the line connecting two concave portions 132 with the convex portion 131 between them can be defined as a flat line.

The convex portion 131 is formed by using half exposure. In other words, the amount of exposure is reduced for the convex portion 131 while the amount of exposure is increased for the concave portion 132. In this way, the concave-convex pattern is formed on the bottom surface of the concavo-convex mount 130. In such a formation method, it is difficult to increase the tilt angle θ shown in FIG. 6. On the other hand, when the tilt angle θ is too small, it is difficult to form a concave-convex pattern that is enough to prevent the oriented film 106 from being formed in the convex portion 131.

According to the experiment on the condition that the oriented film 106 is not formed by the formation process of the concave-convex pattern and by the leveling effect of the concave-convex pattern, the tilt angle θ of FIG. 6 is preferably 3 degrees or more and 45 degrees or less. When θ is smaller than 3 degrees, the effect of reducing the thickness of the oriented film 106 is not determined in the convex portion. Note that as the effect of the present invention, it is possible to achieve a certain effect not only in the case in which the oriented film 106 is completely absent in the convex portion 131, but also in the case in which the thickness of the oriented film in the concave portion is thinner than in the convex portion 131. The value of θ is, more preferably, 6 degrees or more and 25 degrees or less.

FIG. 7 is a plan view showing a part of the display area. In FIG. 7, the image signal liens 20 extend in the vertical direction and are arranged in the horizontal direction at a predetermined pitch. Scan lines 10 extend in the horizontal direction and are arranged in the vertical direction at a predetermined pitch. Note that only one scan line 10 is shown in FIG. 7. A part of the image signal line 20 is branched to form a drain electrode 21. A source electrode 22 facing the drain electrode 21 is connected to the pixel electrode. The scan line 10 also serves as the gate of the TFT.

The cylindrical spacer 150 is formed on the image signal line 20. In the present invention, the cylindrical spacer 150 is formed in the TFT substrate 100. The black matrix 201 is formed in the counter substrate 200 so as to cover the cylindrical spacer 150, the TFT, the image signal lines 20, the scan line 10, and the like, as shown in the dotted lines in FIG. 7. The orientation of the liquid crystal is disturbed in the area where the cylindrical spacer 150 is formed, so that light leakage or other failure occurs, which is prevented by the black matrix 201 formed in the counter substrate 200.

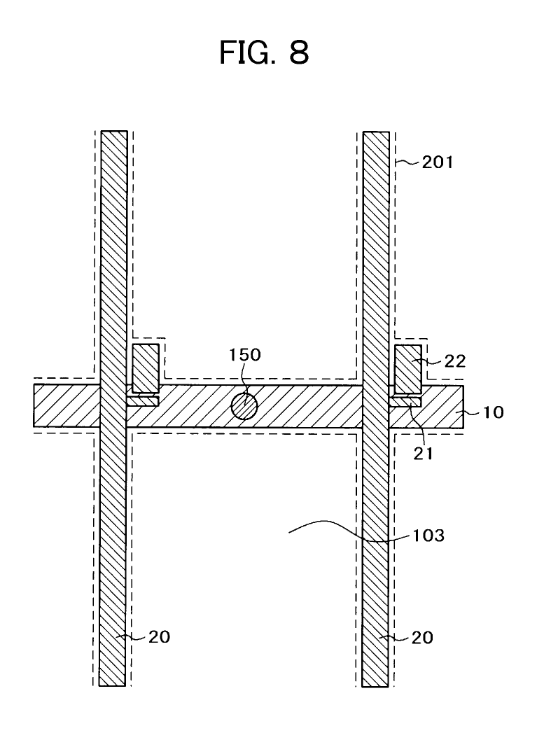

FIG. 8 shows the state in which the cylindrical spacer 150 is formed on the scan line 10 and not on the image signal line 20, with the same configuration as in FIG. 7. The width of the scan line 10 is greater than the width of the image signal line 20. Thus, it is possible to prevent the light leakage due to the orientational disorder of the liquid crystal caused by the cylindrical spacer 150 more effectively. Note that the cylindrical spacer 150 can be formed not only on the image signal line 20 or on the scan line 10, but also on the intersection of the image signal line 20 and the scan line 10 or on the TFT, and the like.

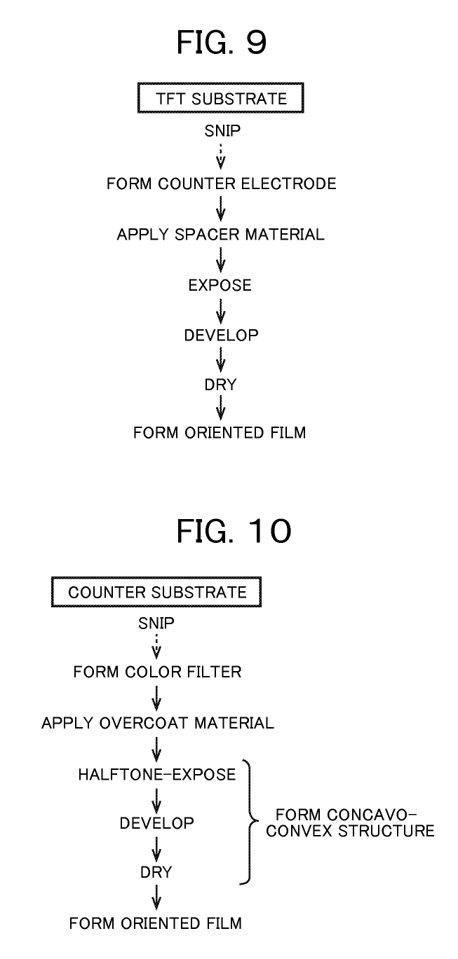

FIG. 9 is a part of the manufacturing flow of the TFT substrate 100, which is related to the present invention. In FIG. 9, the counter electrode 105 is formed from indium tin oxide (ITO) on the interlayer insulating film 104 shown in FIG. 1. Then, a spacer material is applied to form the cylindrical spacer 150. The thickness of the spacer material is the same as the height of the cylindrical spacer 150, for example, is 3 to 4 μm. Then, the applied spacer material is exposed, developed, and dried to form the cylindrical spacer 150. Then, the oriented film 106 is applied. The oriented film 106 is not formed on the top of the cylindrical spacer 150 by the leveling effect.

FIG. 10 is a part of the manufacturing flow of the counter substrate 200, which is related to the present invention. In FIG. 10, after the color filters 202 are formed, the overcoat material 203 is applied. The overcoat material 203 applied to the portion of the concavo-convex mount 130 is half-exposed, developed, and dried to form the concavo-convex mount 130, and then the oriented film 106 is applied. The oriented film 106 is also applied to the portion of the concavo-convex mount 130. However, the oriented film 106 is not applied to the convex portion 131 of the concavo-convex mount 130 by the leveling effect.

Then, for example, the sealing material 140 is formed in the periphery of the counter substrate 200. Then, the liquid crystal is dropped into the counter substrate 200. This process is called One Drop Fill (ODF). Then, the counter substrate 200 and the TFT substrate 100 are bonded together to form the liquid crystal display device. In the liquid crystal display device formed as described above, the oriented film is not formed on the cylindrical spacer 150 and in the convex portion of the concavo-convex mount 130. Thus, when horizontal displacement or other failure occurs in the TFT substrate 100 or in the counter substrate 200, bright spots due to the scraping of the oriented film may not occur.

### Second Embodiment

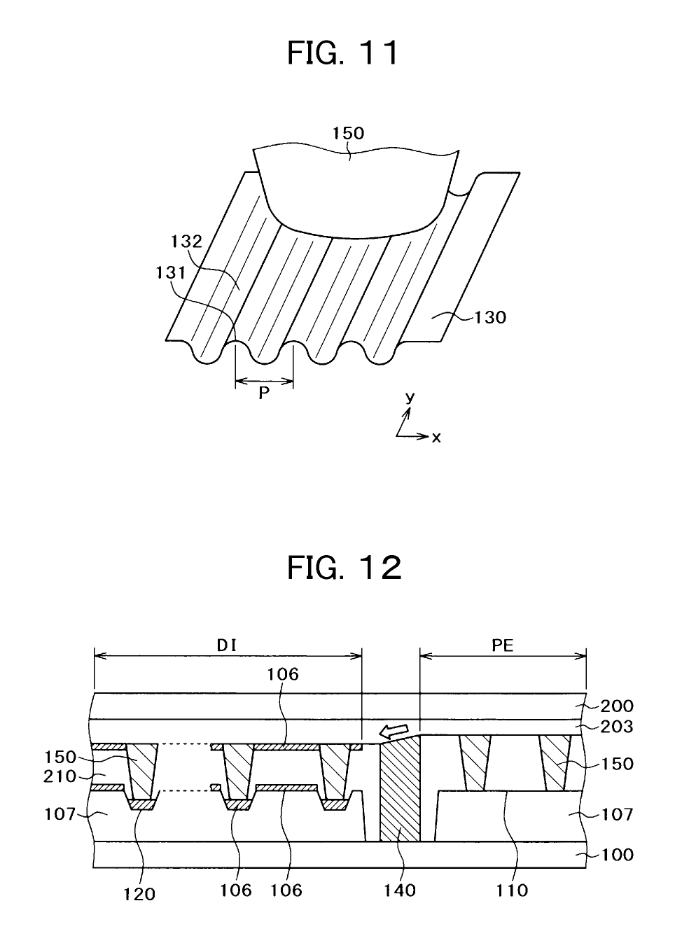

FIG. 11 is a perspective view showing the shape of the bottom surface of the concavo-convex mount 130 according to a second embodiment of the present invention. The concavo-convex mount 130 is formed in the overcoat film 203 of the counter substrate 200. In FIG. 11, the concave-convex pattern of the bottom surface of the concavo-convex mount 130 is formed only in one direction (x-direction). In other words, in FIG. 11, the concave-convex pattern is sequentially formed in the horizontal direction (x-direction) at a predetermined pitch P, and the ridge of the concave portion 131 is formed in the vertical direction (y-direction). Also in the shape of FIG. 11, the oriented film 106 is not present in the convex portion 131. The oriented film 106 is made thick in the concave portion 132.

In FIG. 11, the cylindrical spacer 150 is brought into contact with the convex portion 131. However, the oriented film 106 is not present in the convex portion 131. Thus, the oriented film 106 would not be scraped if the cylindrical spacer 150 is displaced in the horizontal direction. In FIG. 11, in order to prevent that the cylindrical spacer 150 is tilted and brought into contact with the concave portion 132 in which the oriented film is made thick, the cylindrical spacer 150 should contact at least two concave portions 131. In other words, in FIG. 11, the diameter of the top of the cylindrical spacer 150 should be large enough to contact at least two convex portions 131 in the x-direction. Preferably, the diameter of the top of the cylindrical spacer 150 is large enough to contact three or more convex portions 131 in the x-direction.

In FIG. 11, the tilt angle θ in the shape of the cross section of the concave portion 131 is the same as the case of the concave portion 131 with the circular-shaped cross section shown in FIG. 6. That is, the cross section in the x direction in FIG. 11 corresponds to the cross section in FIG. 6. In other words, also in the second embodiment, according to the condition that the oriented film 106 is not formed by the formation process of the concave-convex pattern and by the leveling effect of the concave-convex pattern, the tilt angle θ in FIG. 6 is preferably 3 degrees or more and 45 degrees or less. When θ is smaller than 3 degrees, the effect of reducing the oriented film 106 is not determined in the concave portion 131. Note that as the effect of the present invention, it is possible to achieve a certain effect not only in the case in which the oriented film 106 is completely absent in the convex portion 131, but also in the case in which the thickness of the oriented film 106 in the concave portion 132 is thinner than in the convex portion 131. The value of θ is, more preferably, 6 degrees or more and 25 degrees or less.

In FIG. 11, the extending direction of the convex portion 131 in the bottom surface of the concavo-convex mount 130, namely, the extending direction of the ridge 131 is the y-direction which is the extending direction of the image signal line in FIG. 8. However, the extending direction of the ridge 131 in FIG. 11 is not limited to the y-direction, and may be the x-direction. Further, the ridge 131 formed on the bottom surface of the concavo-convex mount 130 may have a predetermined angle not only with respect to the x-direction or the y-direction, but also with respect to both the x-direction and the y-direction. Whatever the direction of the ridge 131, it is important that the top of the cylindrical spacer 150 is brought into contact with two or more ridges 131, and more preferably, three or more ridges 131. In this case, the top of the cylindrical spacer 150 should contact two or more, more preferably, three or more ridges in the direction perpendicular to the extending direction of the ridges.

The liquid crystal display device has two methods of injecting liquid crystal. One is the vacuum injection method for evacuating the liquid crystal display device to inject liquid crystal from an injected hole into the liquid crystal display device. The other is the One Drop Fill (ODF) method for dropping liquid crystal to the inside of the liquid crystal display device by forming the sealing material in the periphery of the counter substrate. Of the two methods, the ODF method requires precise control of the amount of liquid crystal to be dropped. When the number of cylindrical spacers 150 formed in the counter substrate 200 is large, it is difficult to control the amount of liquid crystal to be dropped. In addition, it is also difficult to control the gap between the TFT substrate 100 and the counter substrate 200 due to the variation in the layout of the cylindrical spacers 150.

Thus, in the ODF method, the number of the cylindrical spacers 150 is smaller than that in the vacuum injection method. As a result, when the liquid crystal display device is subject to a thermal cycle or when an external pressure is applied, the stress and distortion on one cylindrical spacer 150 increase. In other words, the horizontal displacement of the cylindrical spacer 150 increases. As a result, the scraping of the oriented film is more likely to occur in the ODF method.

Thus, in particular, it is possible to increase the effect by applying the present invention to the liquid crystal display device in which the liquid crystal is injected by the ODF method.

In the configuration described above, the concavo-convex mount 130 is formed in the overcoat film 203 of the counter substrate 200. However, the overcoat film 203 may not be formed depending on the type of the liquid crystal display device. In such a case, it is possible to form the concavo-convex mount 130 in the black matrix 201 that is formed on the counter substrate 200 of the part facing the cylindrical spacer 150 formed in the TFT substrate 100. Further, when the black matrix 201 is not present in the counter substrate 200 of the part facing the cylindrical spacer 150, it is possible to form the concavo-convex mount 130 in the color filter 202 that is formed in the counter substrate 200 of the part facing the cylindrical spacer 150.

Further, when the counter electrode 105 is formed in the counter substrate 200, the concavo-convex mount 130 is formed in the counter substrate 200, and then the counter electrode 105 formed from ITO which is the transparent electrode. Then, the oriented film 106 is formed. Also in this configuration, it is possible to eliminate the oriented film in the concave portion with which the cylindrical spacer 150 is brought into contact or to make the oriented film very thin in the concavo-convex mount 130. In this way, it is possible to prevent the occurrence of bright spots due to the scraping of the oriented film.

Further, in the above description, it is assumed that the organic passivation film is not present on the side of the TFT substrate. However, even if the organic passivation film is present on the side of the TFT substrate, the cylindrical spacer can be formed on the side of the TFT substrate, and the concavo-convex mount can be formed in the overcoat film and the like on the side of the counter substrate, similarly to the case of using the organic passivation film on the side of the TFT substrate.

What is claimed is:

1. A liquid crystal display device comprising:
a TFT substrate including a display area in which pixels each having a pixel electrode and a TFT are arranged in a matrix form, and a peripheral area of the display area;
a counter substrate in which an overcoat film is formed on a black matrix and color filters; and
a liquid crystal sandwiched between the TFT substrate and the counter substrate,
wherein the counter substrate includes a display area corresponding to the display area of the TFT substrate and a peripheral area having a flat portion corresponding to the peripheral area of the TFT substrate,
wherein the gap between the TFT substrate and the counter substrate is defined by a cylindrical spacer formed in the TFT substrate,
wherein a concavo-convex mount facing the cylindrical spacer is formed in the display area of the overcoat film of the counter substrate,
wherein a convex portion and a concave portion are formed on the bottom surface of the concavo-convex mount,
wherein the top of the convex portion is lower than the flat portion,
wherein the thickness of an oriented film present in the convex portion is smaller than the thickness of an oriented film present in the concave portion,
wherein the top of the cylindrical spacer is brought into contact with two or more convex portions formed on a bottom surface of the concavo-convex mount, and
wherein the diameter of the bottom surface of the concavo-convex mount is greater than the diameter of the top of the cylindrical spacer.

2. The liquid crystal display device according to claim 1, wherein the cylindrical spacer formed in the peripheral area of the TFT substrate is brought into contact with a flat mount of the overcoat film in the peripheral area of the counter substrate.

3. The liquid crystal display device according to claim 1, wherein an organic passivation film is not present in the TFT substrate.

4. The liquid crystal display device according to claim 3, wherein the tilt angle of a tilt portion in a cross section shape of the concave portion of the concavo-convex mount is 6 degrees or more and 25 degrees or less.

5. The liquid crystal display device according to claim 4, wherein the tilt angle of the tilt portion in the cross section shape of the convex portion of the concavo-convex mount is 3 degrees or more and 45 degrees or less.

6. The liquid crystal display device according to claim 3, wherein the liquid crystal is injected by One Drop Fill (ODF) method.

7. A liquid crystal display device comprising:
a TFT substrate including a display area in which pixels each having a pixel electrode and a TFT are arranged in a matrix form, and a peripheral area of the display area;
a counter substrate in which a black matrix and color filters are arranged; and
a liquid crystal sandwiched between the TFT substrate and the counter substrate,
wherein the counter substrate includes a display area corresponding to the display area of the TFT substrate and a peripheral area having a flat portion corresponding to the peripheral area of the TFT substrate,
wherein the gap between the TFT substrate and the counter substrate is defined by a cylindrical spacer formed in the TFT substrate,
wherein a concavo-convex mount facing the cylindrical spacer is formed in the display area of the black matrix of the counter substrate,
wherein a convex portion and a concave portion are formed on the bottom surface of the concavo-convex mount,
wherein the top of the convex portion is lower than the flat portion,
wherein the thickness of an oriented film present in the convex portion is smaller than the thickness of an oriented film present in the concave portion,
wherein the top of the cylindrical spacer is brought into contact with two or more convex portions formed on a bottom surface of the concavo-convex mount,
wherein the diameter of the bottom surface of the concavo-convex mount is greater than the diameter of the top of the cylindrical spacer, and
wherein the cylindrical spacer formed in the peripheral area of the TFT substrate is brought into contact with a flat mount of the black matrix in the peripheral area of the counter substrate.

8. The liquid crystal display device according to claim 7, wherein an organic passivation film is not present in the TFT substrate.

9. A liquid crystal display device comprising:
a TFT substrate including a display area in which pixels each having a pixel electrode and a TFT are arranged in a matrix form, and a peripheral area of the display area;
a counter substrate in which a black matrix and color filters are arranged; and
a liquid crystal sandwiched between the TFT substrate and the counter substrate,
wherein the counter substrate includes a display area corresponding to the display area of the TFT substrate and a peripheral area having a flat portion corresponding to the peripheral area of the TFT substrate,
wherein the gap between the TFT substrate and the counter substrate is defined by a cylindrical spacer formed in the TFT substrate,
wherein a concavo-convex mount facing the cylindrical spacer is formed in the display area of the color filter of the counter substrate,
wherein a convex portion and a concave portion are formed on the bottom surface of the concavo-convex mount,
wherein the top of the convex portion is lower than the flat portion,
wherein the thickness of an oriented film present in the convex portion is smaller than the thickness of an oriented film present in the concave portion,
wherein the top of the cylindrical spacer is brought into contact with two or more convex portions formed on a bottom surface of the concavo-convex mount,
wherein the diameter of the bottom surface of the concavo-convex mount is greater than the diameter of the top of the cylindrical spacer, and
wherein the cylindrical spacer formed in the peripheral area of the TFT substrate is brought into contact with a flat mount of the color filter in the peripheral area of the counter substrate.

10. The liquid crystal display device according to claim 9, wherein an organic passivation film is not present in the TFT substrate.
